(19) United States
(12) Patent Application Publication
(10) Pub. No.: US 2003/0145413 A1
(43) Pub. Date: Aug. 7, 2003

(54) Wiper arm, in particular for a motor vehicle and method for producing the same

(76) Inventor: Joachim Zimmer, Sasbach (DE)

Correspondence Address: Striker Striker & Stenby, 103 East Neck Road, Huntington, NY, 11743, US

(21) Appl. No.: 10/297,500

(22) PCT Filed: Dec. 29, 2001
(86) PCT No.: PCT/DE01/04943

(30) Foreign Application Priority Data
May 9, 2001 (DE) 101 22 458.3

(51) Int. Cl. B60S 1/32

(52) U.S. Cl. 15/250.351; 29/428

(57) ABSTRACT

A wiper arm (10) and a method for producing a wiper arm (18) are proposed, in which the wiper arm (18) comprises a U-shaped profile section (24) and a bottom (34), which is secured at some points to the profile section (24).

### PRIOR ART

The invention relates to a wiper arm, in particular for a motor vehicle, and to a method for producing such a wiper arm, as generically defined by the preamble to the independent claims.

Numerous wiper arms are already known that connect a wiper shaft, movable in pendulum fashion, to a wiper blade and serve to transmit the requisite force for moving the wiper blade over the windshield from the wiper shaft to the wiper blade and generate the requisite contact pressure of the-wiper blade against the windshield. Because of the high torques to be transmitted, it is necessary for the joint part to be as lightweight as possible yet nevertheless have high flexural and torsional strength.

### ADVANTAGES OF THE INVENTION

The wiper arm of the invention having the characteristics of the main claim has the advantage that by the insertion of a bottom into a U-shaped profile section, a closed rectangular profile with flexural and torsional strength is created. It is also advantageous in this respect that the wall thicknesses of both parts, that is, the bottom and the U-shaped profile section, can be kept less than if only a plain U-shaped profile section were used. If the bottom is furthermore secured to the lateral flanks only at some points, the profile can be produced very easily and economically. Moreover, this produces a smooth-surfaced bottom of the wiper arm, which improves the flow of air around the wiper arm.

Since the masses in motion of the wiper system are reduced markedly, the bearings of the wiper shafts can also be made smaller. Moreover, the lesser masses mean less wear on the bearings.

Because the visible top of the wiper arm is embodied in one piece by an inverted-U-shaped profile section, not only are dangerous edges on the top avoided but the design of the wiper arm is unimpaired compared to modern wiper arms.

By the provisions recited in the dependent claims, advantageous refinements of and improvements to the characteristics recited in the main claim are obtained.

It is especially advantageous if the bottom is secured to the lateral flanks by a welding process. Particularly by means of projection welding, all the fastening points can be welded simultaneously, economically, and quickly.

It is advantageous if the lateral flanks have a plurality of swaged features, on which the bottom can come to rest upon being inserted into the profile section. In mass production, the bottom can as a result be inserted into the profile section without dropping into the interior of the U-shaped profile section, making it possible to dispense with further positioning tabs or other positioning aids.

Advantageously, the bottom has lugs, along its long sides that are oriented toward the lateral flanks, which can also engage the swaged features of the lateral flanks.

It is especially advantageous if at least one, but preferably two gaps, in particular facing one another, are provided between the lateral flanks and the bottom, in order to keep the electrical currents in the projection welding low and nevertheless to attain a durable connection.

It is also advantageous if the bottom has at least one receptacle for a spring device, because then no further tab or bolt is needed to fasten a tension spring between the joint part and the fastening part. The result is a substantial reduction in both cost and weight. Omitting the lapping over of the spring suspension eliminates some steps in production and achieves a markedly improved contour, which minimizes waste and thus saves material.

It is also considered to be a further advantage of the connection points of the bottom are located closer to the base than the edges, facing away from the base, of the lateral flanks of the profile section. In this way, the bottom is let into the profile section and is not apparent when the wiper arm is seen from the side, since the lateral flanks protrude past the bottom. Moreover, the weld points and the bottom are protected against environmental factors, such as salt air, etc.

It is also advantageous, to improve the corrosion resistance, for the wiper arm to be made from zinc-plated sheet metal or zinc-plated sheet steel. The remote action of the zinc also protects the weld points and cut edges against corrosion. Moreover, further surface treatment is no longer needed before the wiper arms are painted.

It is furthermore especially advantageous if the bottom has holes, so that the bottom improves the stability of the profile section yet increases the weight of the wiper arm only minimally. The provision of the holes can be determined by a finite elements process, for instance.

The method of the invention for producing the wiper arm, as defined by the characteristics of claim 11, has the advantage that by stamping out a bottom and inserting it into the profile section, the stability of the profile section and hence the stability of the wiper arm are enhanced, without increasing the weight of the wiper arm. Because the bottom is secured to at least one lateral flank by the projection welding process, a simple, economical way of increasing the stability of the profile section is attained.

In a simple version, it is naturally possible to dispense with a welding process, and to secure the bottom to the lateral flanks merely by means of clamps.

### DRAWINGS

One exemplary embodiment of the invention is shown in the drawings and described in further detail in the description below. Shown are:

FIG. 1, a schematic view of a wiper system;

FIG. 2, a wiper arm of the prior art, in perspective;

FIG. 3, the joint part of a wiper arm of a wiper system of the invention, in perspective;

FIG. 4, a wiper arm of a wiper system of the invention, in perspective;

FIG. 5, a fastening end of a wiper arm, in perspective;

FIG. 6, the fastening end of a wiper arm in a variation, in perspective;

FIG. 7, a view into the interior of a wiper arm, in perspective;

FIG. 8, a swaging point of a lateral flank of a wiper arm, in perspective;

FIG. 9, the steps in the method of the invention, shown schematically; and

FIG. 10, a detailed view of the swaging steps of the method of the invention.

### DESCRIPTION OF THE EXEMPLARY EMBODIMENT

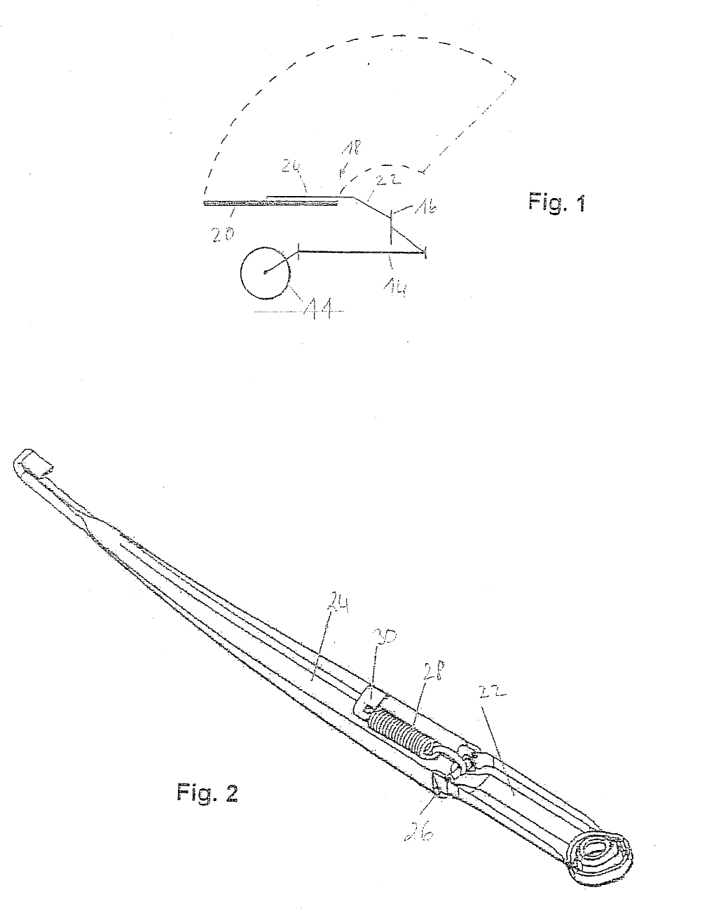

FIG. 1 shows a wiper system 10 of the invention schematically. By means of a wiper motor 11, via a rod linkage 14 embodied for instance as a crank gear, a wiper shaft 16 is driven in pendulum fashion. The wiper arm 18 is connected in a manner fixed against relative rotation to the wiper shaft 16 and, on its end remote from the wiper shaft 16, it has a wiper blade 20. The wiper arm 18 substantially comprises a fastening part 22 and a joint part 24, and the fastening part 22 connects the joint part 24 to the wiper shaft 16 in a manner fixed against relative rotation.

The cranking motion of the wiper motor 12, via the rod linkage 14, creates a pendulum motion of the wiper arm 18. This causes constant alternations of load in the region of the wiper arm 18, since the wiper blade 20 that is connected to one end of the wiper arm 18 acts counter to the pendulum motion because of its friction with the window, not shown.

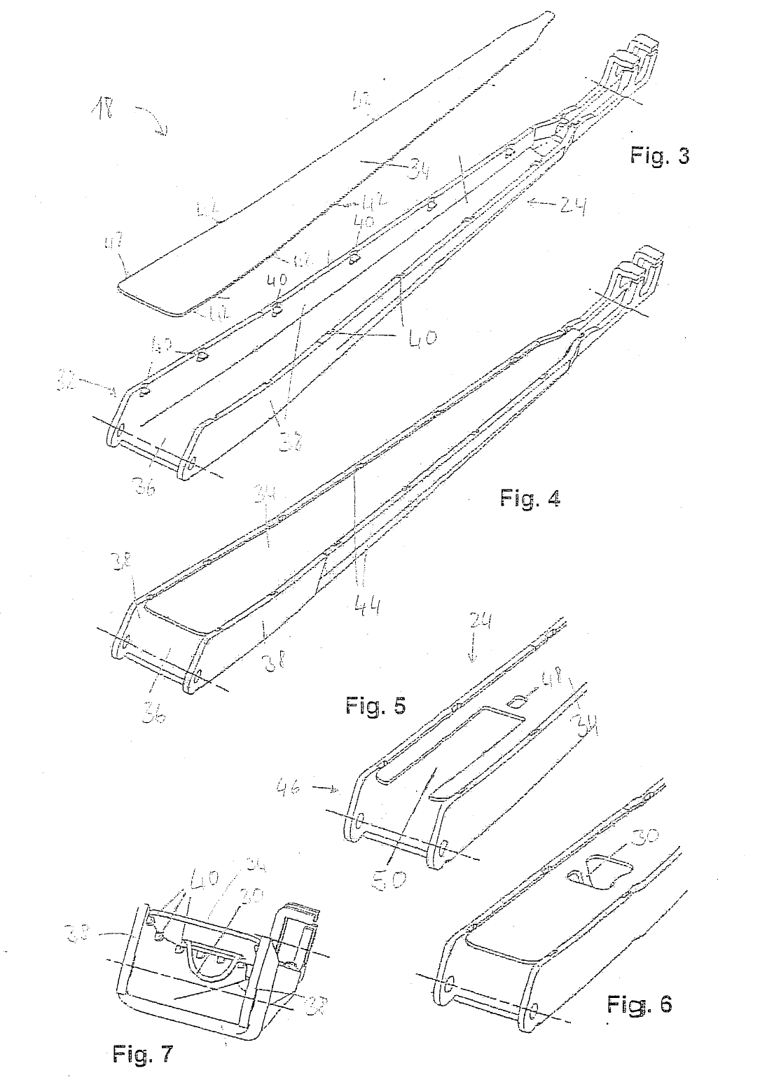

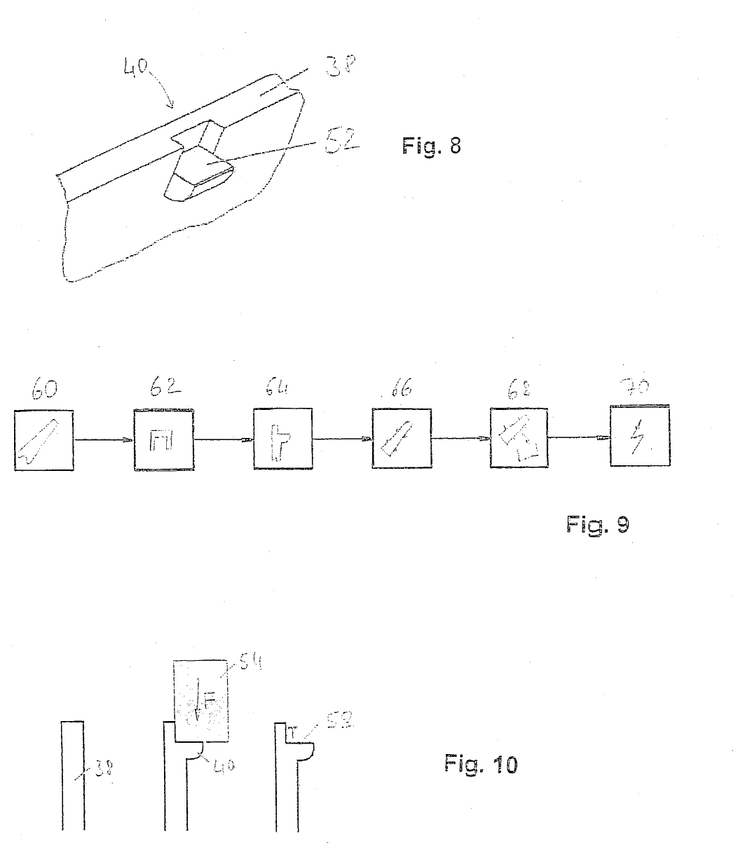

FIG. 2 shows a wiper arm of the prior art. The joint part 24 is connected rotatably to the fastening part 22 by means of a bolt 26. In addition, the fastening part 22 and joint part 24 are braced via a spring device 28, embodied for instance as a tension spring. For this bracing, the spring device 28 is hooked to the joint part 24 in a tab 30, which is formed as a lapping over from the edge, remote from the base, of the lateral flank. The other end of the spring device 28 is secured at a fastening point to the fastening part, which point is located outside the pivot axis between the fastening part 22 and the joint part 24.

FIG. 3 shows a joint part 24 of a wiper system 10 of the invention during the production process.

The joint part 24 of the wiper arm 18 comprises a profile section 32 and a bottom 34. The profile section 32 is essentially U-shaped and therefore has a base 36 with two lateral flanks 38. On the edges remote from the base, swaged features 40 are disposed on the lateral flanks 38. The bottom 34 is stamped out as a flat sheet-metal part and is embodied such that it essentially follows the contour of the lateral flanks 38. In this way, the bottom 34 is fitted precisely into the U-shaped profile, specifically in such a way that when the bottom 34 is placed in the profile section 32, it touches the profile section only at the swaged features 40.

To enlarge the bearing area, the bottom 34 has lugs 42, on its long sides 41 oriented toward the lateral flanks 38.

FIG. 4 shows a joint part 24 of a wiper system 10 of the invention with the bottom 34 put in place. Because the bottom 34 touches the lateral flanks 38 only in the region of the swaged features 40, two opposed gaps 44 are created. The bottom 34 is welded to the profile sections 32 at the swaged features 40.

In FIG. 5, one fastening end 46 of a joint part 24 is shown in perspective. The bottom 34 has a receptacle 48, which is embodied as a hole. One end of the spring device 28 (FIG. 2) can be hooked into this hole. The bottom 34 also has a recess 50, in order to create enough room for the spring device 28.

However, the spring device 28 can also be disposed entirely inside the wiper arm 18. As shown in FIG. 6, to that end a tab 30 can be formed out of the bottom 26, and this tab extends semicircularly out of the plane of the bottom 34 into the interior of the profile section 32. This variation of the invention is shown again in FIG. 7.

FIG. 7 shows a view into the fastening end 46 of the wiper arm 18 in perspective. It can be seen clearly here as well that the swaged features 40 extend so far in the direction of the base 36 that the bottom 34 disappears entirely inside the profile section 32, in other words, that the outer plane of the bottom 34 is located closer to the base 36 than a plane that is defined by the edges, remote from the base, of the two lateral flanks 38.

In FIG. 8, the swaged feature 40 on the lateral flank 38 is shown in detail. With a swaging die, part of the lateral flank 38 has been swaged on the inside of the U-shaped profile section 32 in such a way that a plateau 52 is created by the material swaged in the direction of the base. The bottom 34 can then come to rest on this plateau 52.

In FIG. 9, the method of the invention is shown in detail in its individual steps. In a first stamping step 60, the profile section 32 is stamped out of a flat metal sheet. In the second, bending step 62, the stamped-out but still-flat profile section 32 is bent into a U shape. In the swaging step 64 that follows, the swaged features 40 with the plateaus 52 are made at the fastening points. This is followed by the bottom stamping step 66, in which the sheet-metal bottom is stamped out together with the lugs 42. In the insertion step 68 that follows, the bottom 34 is inserted into the profile section 32, and in the ensuing welding step, by the application of a voltage between the bottom 34 and the profile section 32, these parts are welded together at the swaging points by the projection welding process.

In FIG. 10, the swaging step 64 is shown in somewhat more detail. A swaging die 54 is placed against the edge, remote from the base, of the lateral flank 38. This die has the desired width of the swaged feature 40 and is positioned approximately in the middle of the cross section of the lateral flank on the edge remote from the base. By means of a force F that acts on the swaging die 54, the material of the lateral flank 38 is pressed in the direction of the base, thus creating the plateau 52 from the material positively displaced by the die 54. The depth T of the swaged feature 40, that is, the spacing between the edge, remote from the base, of the lateral flank 38 and the plateau 42 is at least as great as the thickness of the bottom 34.

Naturally, like the joint part 24, the fastening part 22 can also be provided with a bottom 34 of this kind. It is also conceivable to omit the swaged features 40 and instead to have the bottom 34 merely rest on the edge, remote from the base, of the lateral flank 38 with the aid of the lugs 42 and to weld it there.

In a simple variation of the invention, however, the bottom 34 can also be secured to the lateral flanks 38 only by clamps. In that case, in production, first only every other one of the swaged features 40 can then be made, for instance; then the bottom 34 can be put in place and then the swaged features 40 in between can be made, so that the bottom 34 is alternatingly held from the inside and the outside by the swaged features 40.

1. A wiper arm, in particular for a motor vehicle, which is capable of connecting a wiper shaft (16) that is movable in pendulum fashion to a wiper blade (20), and which comprises at least one at least partly inverted-U-shaped profile section (32), with a base (36) and two lateral flanks (38), characterized in that the profile section (32) is provided at least in part with at least one bottom (34), which is secured to the lateral flanks (38) only at some points.

2. The wiper arm of claim 1, characterized in that the lateral flanks (38) have a plurality of swaged features (40), in particular opposite one another in pairs.

3. The wiper arm of one of the foregoing claims, characterized in that the bottom is welded to the lateral flanks (38), preferably in a projection welding method.

4. The wiper arm of one of the foregoing claims, characterized in that the bottom (34) has lugs (42), along its long sides (41) that are oriented toward the lateral flanks (38).

5. The wiper arm of one of the foregoing claims, characterized in that at least one and preferably two gaps (44), in particular facing one another, are provided between the lateral flanks (38) and the bottom (34).

6. The wiper arm of one of the foregoing claims, characterized in that the bottom (34) has at least one recess (50) for a spring device (28).

7. The wiper arm of one of the foregoing claims, characterized in that the bottom (34) has at least one receptacle (48) for a spring device (28).

8. The wiper arm of one of the foregoing claims, characterized in that the lateral flanks (38) protrude beyond the bottom (34).

9. The wiper arm of one of the foregoing claims, characterized in that the wiper arm (18) comprises zinc-plated sheet metal.

10. The wiper arm of one of the foregoing claims, characterized in that the bottom (34) has holes to reduce the weight.

11. A method for producing a wiper arm (18), in particular a wiper arm of one of the foregoing claims, having at least the following steps:
stamping out and bending a substantially U-shaped profile section (32) having a base (36) and two lateral flanks (38);
making swaged features on the lateral flanks (38);
stamping out a bottom (34);
inserting the bottom (34) into the profile section (32);
fastening the bottom to at least one lateral flank (38) by welding.

12. A method for producing a wiper arm (18), in particular a wiper arm of one of the foregoing claims, having at least the following steps:
stamping out and bending a substantially U-shaped profile section (32) having a base (36) and two lateral flanks (38);
making swaged features on the lateral flanks (38);
stamping out a bottom (34);
inserting the bottom (34) into the profile section (32);
fastening the bottom to at least one lateral flank (38) by means of further swaged features (40).
